(19) United States
(12) Patent Application Publication
(10) Pub. No.: US 2016/0285218 A1
(43) Pub. Date: Sep. 29, 2016

(54) MICRO UNIVERSAL SERIAL BUS (USB) PLUGS AND SYSTEMS

(71) Applicant: Toshiba Global Commerce Solutions Holdings Corporation, Tokyo (JP)

(72) Inventors: Stacy Arrington, Morrisville, NC (US); Timothy Crockett, Raleigh, NC (US); Jose Figueroa, Knightdale (NC)

(21) Appl. No.: 14/670,395

(22) Filed: Mar. 26, 2015

(51) Int. Cl. H01R 27/02; H01R 13/64; H01R 13/639

(52) U.S. Cl. CPC H01R 27/02; H01R 13/639; H01R 13/64

(57) ABSTRACT

Micro universal serial bus (USB) ports and systems and disclosed. According to an aspect, a micro USB plug includes a housing including multiple sides defining an interior therebetween. An opening is defined within one of the sides. The plug also includes multiple micro USB pins positioned within the opening. Further, the plug includes a ground pin and a power pin positioned within the opening.

### CROSS REFERENCE TO RELATED APPLICATION

This application is related to U.S. Design Patent Application No. ______, titled UNIVERSAL SERIAL BUS (USB) PLUG SYSTEM and filed simultaneously herewith; the disclosure of which is incorporated herein by reference in its entirety.

### FIELD

Embodiments described herein relate to electrical connectors. More particularly, embodiments described herein relate to micro universal serial bus (USB) plugs and systems.

### BACKGROUND

USB is a connector standard that defines cables, connectors, and communication protocols used in a bus connection, communication, and power supply between computing devices and electronic devices. More particularly, USB is a serial interface that is often used in place of RS232 serial interfaces and parallel interfaces to connect peripheral devices (e.g., mice, keyboards, printers, etc.) to computers (e.g., desktop and laptop computers). Many computers are equipped with multiple USB connectors, each of which is designed to mate with a respective USB plug. A typical USB connector is configured with electrical contacts that are designed to couple to electrical contacts external to the USB connector in order to perform data transfer and power supply functions. Some of the electrical contacts of the USB connector are used to couple electrical contacts of a USB plug to the electrical circuitry of the USB connector, Whereas some of the electrical contacts of the USB connector are used to couple the electrical circuitry of the USB connector to conductive traces formed on a motherboard of a computer. Electrical traces on the motherboard route electrical signals between the electrical circuitry of the USB connector and electrical circuitry mounted on the motherboard, such as, for example, a USB controller that is connected to a main processor of the computer.

Micro USB plugs and ports, such as micro USB version 2 and 3 plugs and ports, has a dimension smaller than other USB types of plugs and ports. More particularly, a micro USB is a newer generation specification of mini USB having a dimension reduced by about 60% when compared to mini USB. Such size and dimension can be beneficial for use in small electronics and computing devices.

Micro USB plugs and ports are available in a variety of sizes and shapes. In addition, there are many different electrical and computing applications for USB technologies. For at least these reasons, there is a continuing need for improved micro USB plug and port systems of varying shapes and sizes for different applications.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a front perspective view of an example micro USB plug system in accordance with embodiments of the present disclosure;

FIG. 2 is a rear perspective view of the micro USB plug system shown in FIG. 1;

FIG. 3 is a top view of the micro USB plug system shown in FIG. 1;

FIG. 4 is a front view of the micro USB plug system shown in FIG. 1;

FIG. 5 is a bottom view of the micro USB plug system shown in FIG. 1;

FIG. 6 is a side view of the micro USB plug system shown in FIG. 1;

FIG. 7 is a rear view of the micro USB plug system shown in FIG. 1;

FIG. 8 is a top cross-sectional view of the micro USB plug system shown in FIG. 1;

FIG. 9 is a front perspective view of an example micro USB plug system in accordance with embodiments of the present disclosure;

FIG. 10 is a rear perspective view of the micro USB plug system shown in FIG. 9;

FIG. 11 is a front view of the micro USB plug system shown in FIG. 9;

FIG. 12 is a bottom view of the micro USB plug system shown in FIG. 9;

FIG. 13 is a side view of the micro USB plug system shown in FIG. 9;

FIG. 14 is a rear view of the micro USB plug system shown in FIG. 9;

FIG. 15 is a top cross-sectional view of the micro USB plug system shown in FIG. 9;

FIG. 16 is a rear perspective view of an example micro USB plug system in accordance with embodiments of the present disclosure;

FIG. 17 is a front perspective view of the micro USB plug system shown in FIG. 16;

FIG. 18 is a rear view of the micro USB plug system shown in FIG. 16;

FIG. 19 is a top view of the micro USB plug system shown in FIG. 16;

FIG. 20 is a side view of the micro USB plug system shown in FIG. 16;

FIG. 21 is a front view of the micro USB plug system shown in FIG. 16; and

FIG. 22 is a top cross-sectional view of the micro USB plug system shown in FIG. 16.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

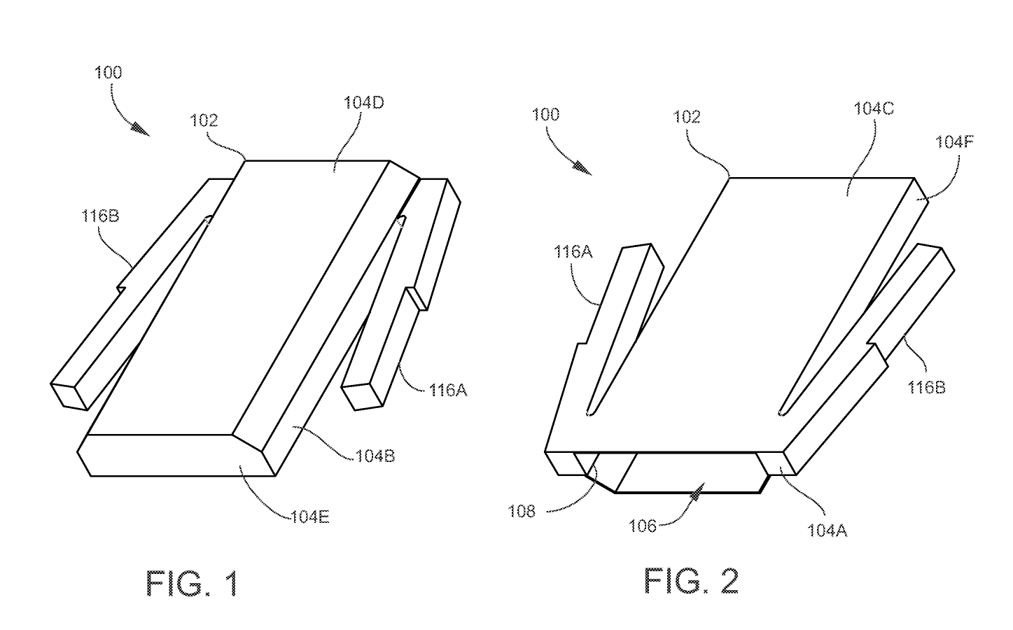

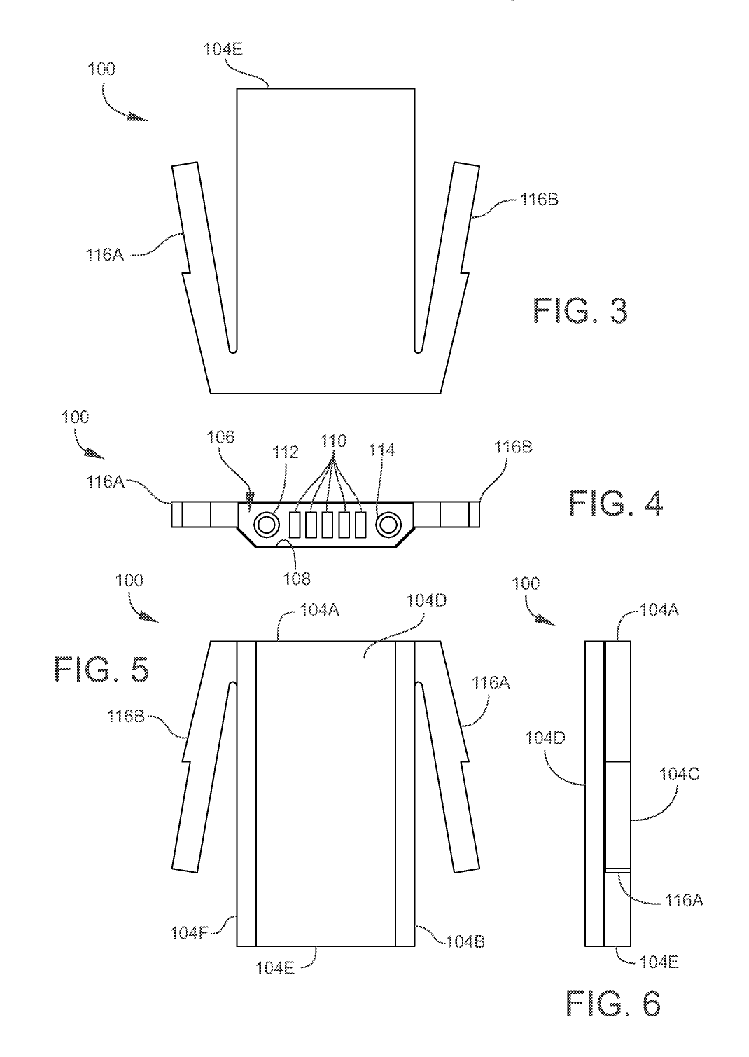

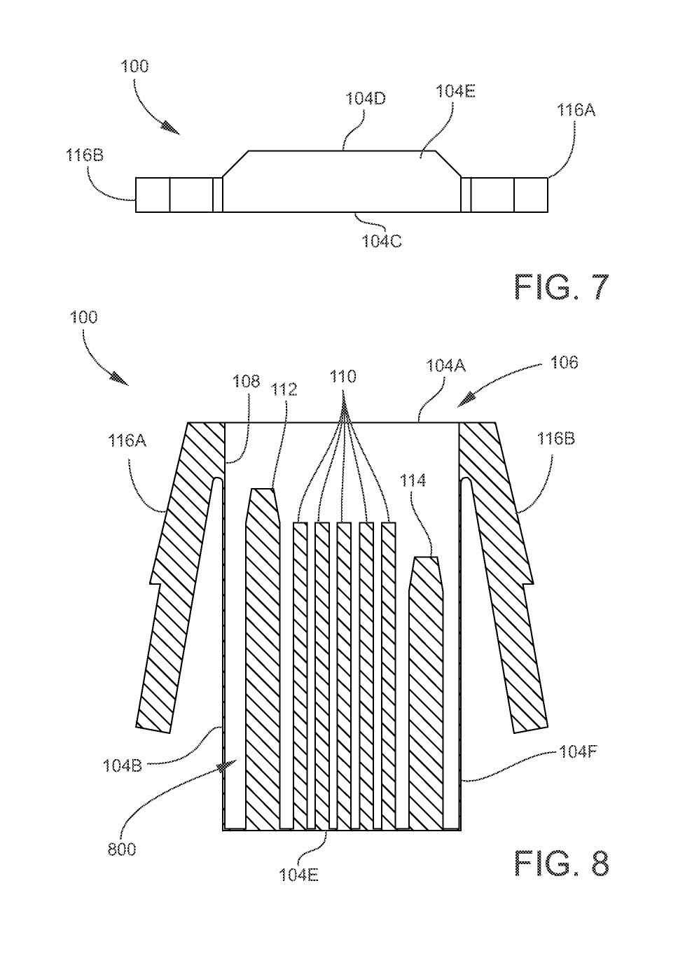

FIGS. 1-8 illustrate different views of an example micro USB plug system 100 in accordance with embodiments of the present disclosure. Particularly, the figure shows a micro-B USB version 2 plug system. Referring to FIGS. 1-8, the system 100 includes a housing 102 having sides 104A-104F. The sides of the housing 102 form an interior 800 therebetween. The housing 102 may be made of a suitable plastic or other type of rigid material as will be understood to those of skill in the art. In this example, the housing 102 is generally an elongated cube in shape; however, it should be understood that the housing 102 may be any suitable shape depending on the application. The housing 102 may be suitably sealed for preventing entry of moisture or contaminants within the interior defined by the sides 104A-104F and shown in FIG. 8, which illustrates a cross-sectional, side view of the system 100.

An opening 106 is defined within side 104A of the housing 102 for receipt of a micro USB connector, such as a mating micro USB plug. A slot 108 formed in the interior of the housing 102 and extends from the opening 106 towards the interior. The slot 106 is structured to receive a micro USB version 2 connector. In an alternative example, for example, the opening 106 and slot 108 may be sized and shaped to receive another suitable type of connector. The slot 108 can function as a constraint feature that prevents engagement with non-micro USB version 3 equipment.

Multiple micro USB pins 110 are positioned within the slot 108 and arranged to be operably connected to a USB version 2 connector. Alternatively, the pins may be arranged to operably connect to any type of micro USB version connector. Pins 110 may include, but not limited to, a V_{CC} pin, a transmit pin, a receive pin. In addition, a ground pin 112 and a power pin 114. The ground pin 112 extends further from the interior than the power pin 114.

The system 100 may include USB version 2 circuitry (not shown in the figures) contained within the interior of the housing 102. The circuitry may be operably connected to the pins 110, 112, and 114. The circuitry may include multiple wires and/or other suitable components for electrically connecting the pins 110, 112, and 114.

A locking mechanism may be suitably attached to the housing 102 for engaging and locking to a USB plug connector. In this example, the locking mechanism includes members 116A and 116B configured to engage to a mating locking mechanism of a USB plug system. Members 116A and 116B may be pliant and resilient for locking to the USB plug connector as will be understood to those of skill in the art.

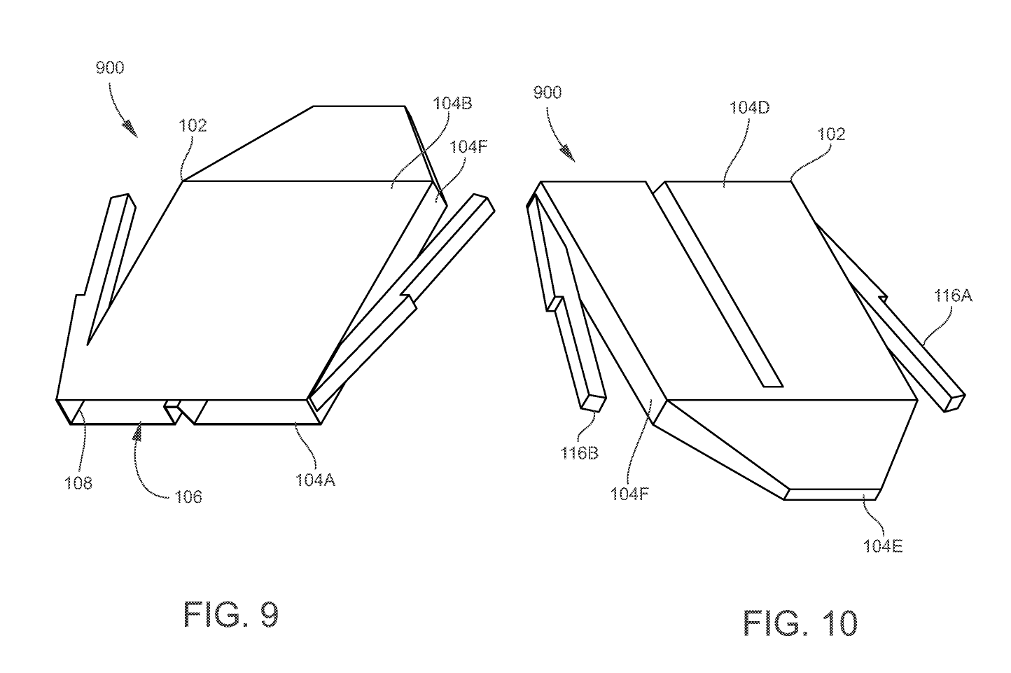

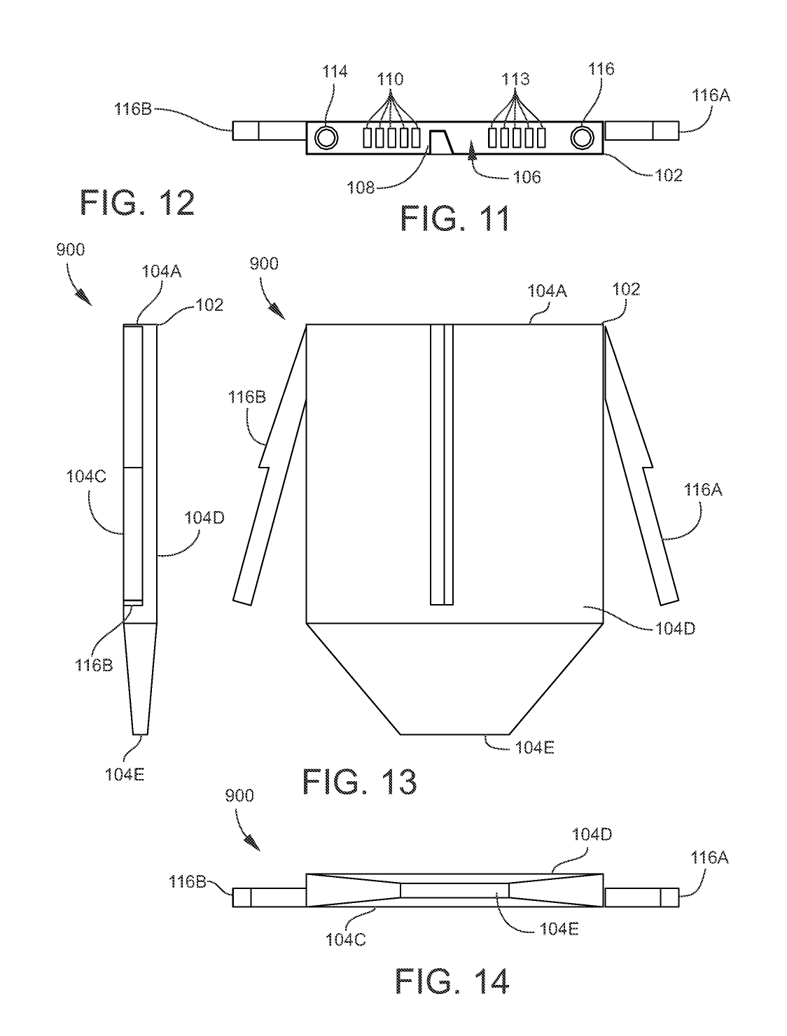

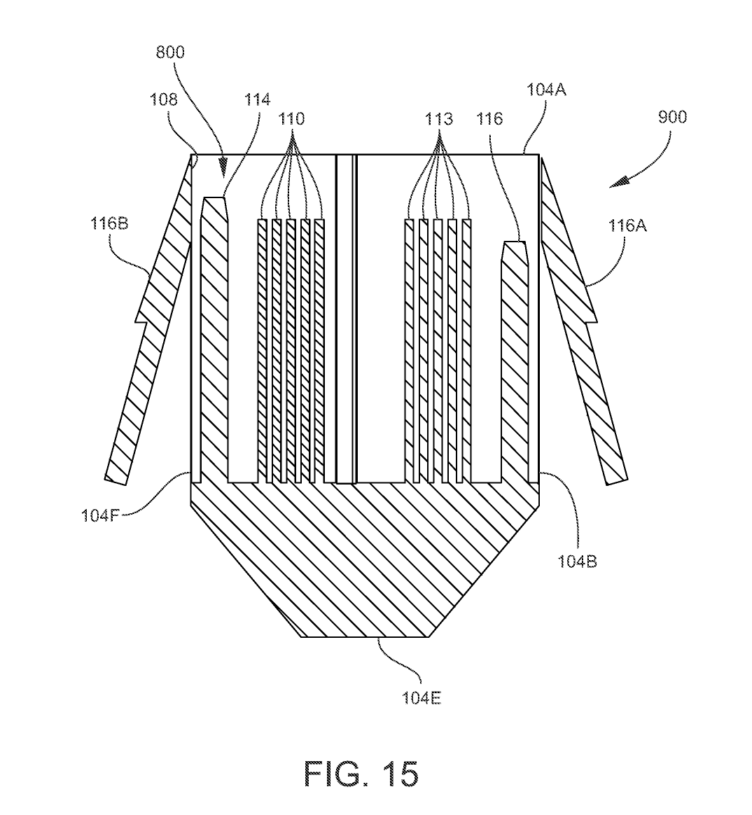

FIGS. 9-15 illustrate different views of another example micro USB plug system 900 in accordance with embodiments of the present disclosure. Particularly, FIGS. 9-15 show a micro-B USB version 3 plug system. Referring to FIGS. 9-15, the system 900 includes a housing 102 having sides 104A-104F. The sides of the housing 102 form an interior 800 therebetween. The housing 102 may be made of a suitable plastic or other type of rigid material as will be understood to those of skill in the art. In this example, the housing 102 may be any suitable shape depending on the application. The housing 102 may be suitably sealed for preventing entry of moisture or contaminants within the interior defined by the sides 104A-104F and shown in FIG. 15, which illustrates a cross-sectional, side view of the system 100.

An opening 106 is defined within side 104A of the housing 102 for receipt of a micro USB connector, such as a mating micro USB version 3 plug. A slot 108 formed in the interior of the housing 102 and extends from the opening 106 towards the interior. The slot 106 is structured to receive a micro USB version 3 connector. In an alternative example, for example, the opening 106 and slot 108 may be sized and shaped to receive another suitable type of connector.

Multiple micro USB pins 110 and 112 are positioned within the slot 108 and arranged to be operably connected to a USB version 2 connector. Pins 110 may be configured for a USB 3.0 portion of a connector. For example, pins 110 may include, but are not limited to, a StdA_SSTX− pin, a StdA_SSTX+ pin, a GND_Drain pin, a StdA_SSRX− pin, and a StdA_SSRX+ pin. Pins 112 may be configured to a USB 2.0 connector. For example, pins 112 may include, but are not limited to, a Vcc, D− pin, a D+ pin, and a ground pin. Alternatively, the pins may be arranged to operably connect to any type of micro USB version connector. In addition, a ground pin 114 and a power pin 116. The ground pin 114 extends further from the interior than the power pin 116.

The system 100 may include USB version 2 circuitry and USB version 3 circuitry (not shown in the figures) contained within the interior of the housing 102. The circuitry may be operably connected to the pins 110, 112, 114, and 116. The circuitry may include multiple wires and/or other suitable components for electrically connecting the pins 110, 112, 114, and 116.

A locking mechanism may be suitably attached to the housing 102 for engaging and locking to a USB plug connector. In this example, the locking mechanism includes members 116A and 116B configured to engage to a mating locking mechanism of a USB plug system. Members 116A and 116B may be pliant and resilient for locking to the USB plug connector as will be understood to those of skill in the art.

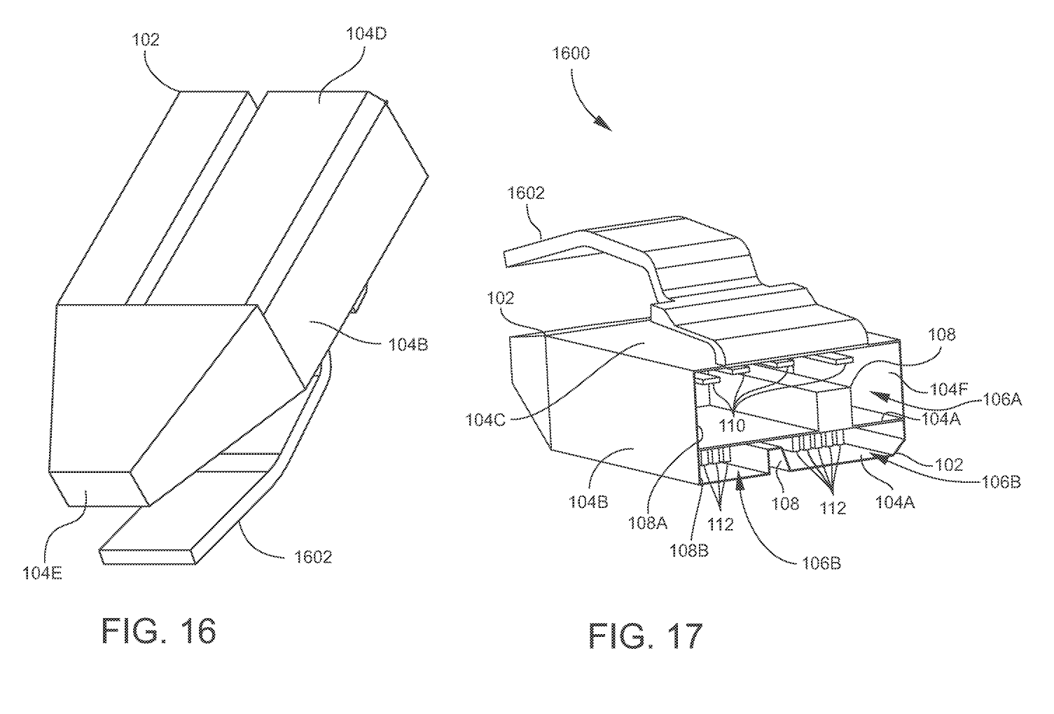

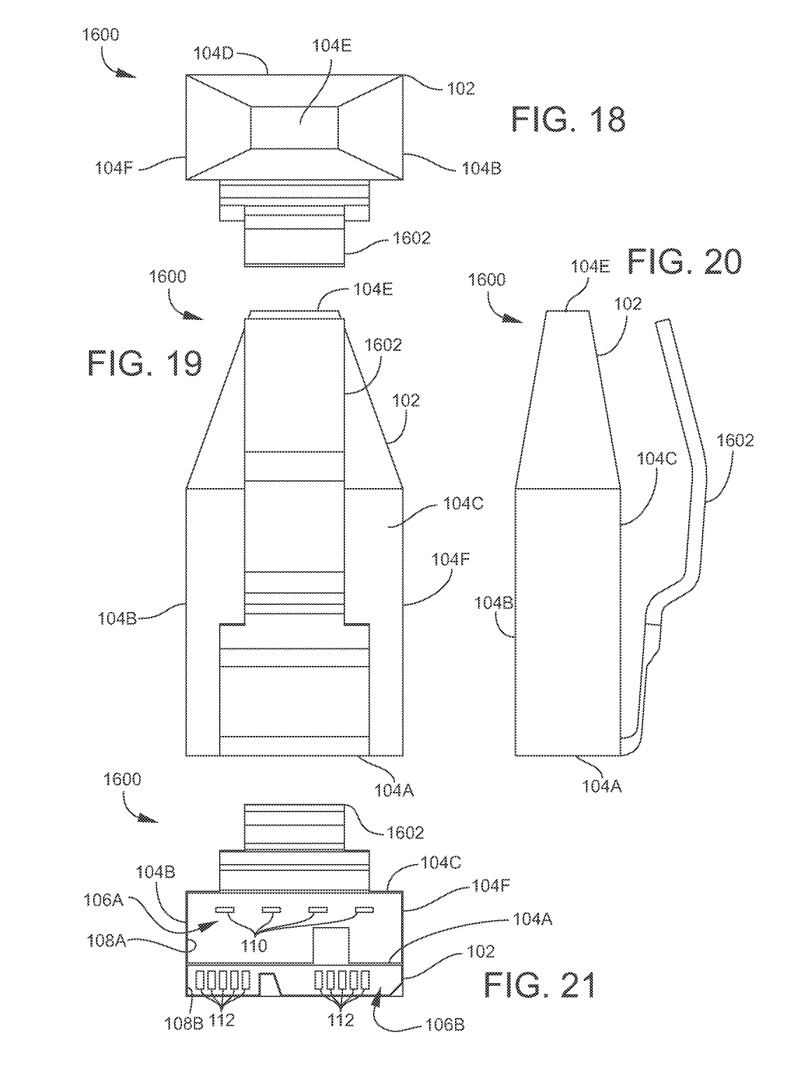

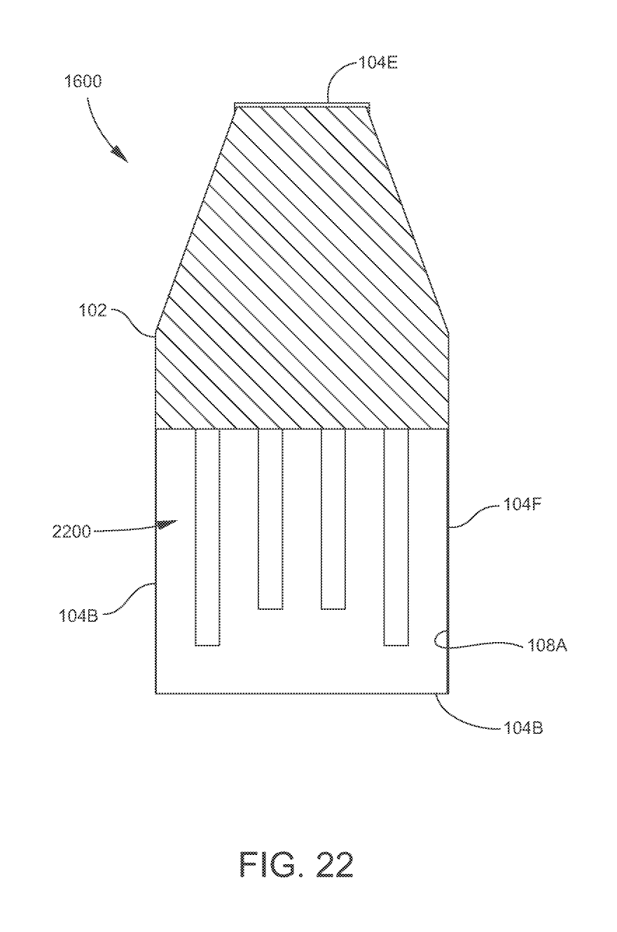

FIGS. 16-22 illustrate different views of another example micro USB plug system 1600 in accordance with embodiments of the present disclosure. Particularly, FIGS. 16-22 show a micro-B USB version 3 plug system. Referring to FIGS. 16-22, the system 1600 includes a housing 102 having sides 104A-104F. The sides of the housing 102 form an interior 2200 therebetween as shown in FIG. 22. The housing 102 may be made of a suitable plastic or other type of rigid material as will be understood to those of skill in the art. In this example, the housing 102 may be any suitable shape depending on the application. The housing 102 may be suitably sealed for preventing entry of moisture or contaminants within the interior defined by the sides 104A-104F and shown in FIG. 22, which illustrates a cross-sectional, top view of the system 100.

Openings 106A and 106B are defined within side 104A of the housing 102 for receipt of micro USB connectors. Particularly, the openings 106A and 106B may receive a mating micro USB version 2 plug and a mating micro USB version 3 plug, respectively. Slots 108A and 108B are formed in the interior of the housing 102 and extend from the openings 106A and 106B, respectively, towards the interior. Slot 106A is structured to receive a micro USB version 2 connector. Slot 106B is structured to receive a micro USB version 3 connector. In an alternative example, for example, openings 106A and 106B and slots 108A and 108B may be suitably sized and shaped to receive other suitable types of connectors.

Multiple micro USB pins 110 and 112 are positioned within slots 108A and 108B, respectively, and arranged to be operably connected to a USB version 2 connector and a USB version 3 connector, respectively. Pins 110 and 112 may be configured for connecting to a USB 2.0 portion and a USB 3.0 portion, respectively, of a connector. For example, pins 110 may include, but are not limited to, a ground, a D+ signal, a D− signal, and a Vcc signal. Also, for example, pins 112 may include, but are not limited to, a StdA SSTX− pin, a StdA SSTX+ pin, a GND_Drain pin, a StdA SSRX− pin, and a StdA_SSRX+ pin. Pins 112 may be configured to a USB 2.0 connector. Alternatively, the pins may be arranged to operably connect to any type of micro USB version connector.

The system 1600 may include USB version 2 circuitry and USB version 3 circuitry (not shown in the figures) contained within the interior of the housing 102. The circuitry may be operably connected to the pins 110 and 112. The circuitry may include multiple wires and/or other suitable components for electrically connecting the pins 110 and 112. The circuitry may include wires for suitably connecting the pins to wires contained within a cord attached to the housing 102.

A locking mechanism 1602 may be suitably attached to the housing 102 for engaging and locking to a mating USB connector. In this example, the locking mechanism 1603 is configured to engage to a mating locking mechanism of a USB connector. The locking mechanism 1602 may be pliant and resilient for locking to the USB connector as will be understood to those of skill in the art.

Slots 108 are formed in the openings 106A and 106B of the housing 102 and extend toward the interior. The slots 106 is structured to receive a micro USB version 2 connector. In an alternative example, for example, the openings 106A and 106B and slots 108 may be sized and shaped to receive other suitable types of connectors. The slots 108 can function as constraint features that prevent engagement with non-micro USB equipment.

While certain embodiments have been described, these embodiments have been presented by way of example only, and are not intended to limit the scope of the presently disclosed subject matter. Indeed, the novel methods, devices, and systems described herein may be embodied in a variety of other forms. Furthermore, various omissions, substitutions, and changes in the form of the methods, devices, and systems described herein may be made without departing from the spirit of the presently disclosed subject matter. The accompanying claims and their equivalents are intended to cover such forms or modifications as would fall within the scope and spirit of the presently disclosed subject matter.

1. A micro universal serial bus (USB) plug comprising:
a housing including a plurality of sides defining an interior therebetween, and including an opening defined within one of the sides, wherein the sides each include a surface that define a boundary of the interior;
a plurality of micro USB pins positioned within the opening and entirely spaced apart from the sides;
a grounding pin positioned within the opening and entirely spaced apart from the sides; and
a power pin positioned within the opening and entirely spaced apart from the sides.

2. The micro USB plug of claim 1, wherein the housing is made of plastic.

3. The micro USB plug of claim 1, wherein the micro USB pins comprise a Vcc pin, a transmit pin, a receive pin, and a ground pin.

4. The micro USB plug of claim 1, further comprising micro USB version 2 circuitry contained within the interior and being operably connected to the micro USB pins.

5. The micro USB plug of claim 1, further comprising micro USB version 3 circuitry contained within the interior and being operably connected to the micro USB pins.

6. The micro USB plug of claim 5, wherein the housing defines a slot extending from the opening to the interior, wherein the slot contains the micro USB pins, the grounding pin, and the power pin.

7. The micro USB plug of claim 6, wherein the slot includes a constraint feature that prevents engagement with non-micro USB version 3 equipment.

8. The micro USB plug of claim 1, wherein the micro USB pins are arranged in a micro-B USB configuration.

9. The micro USB plug of claim 1, wherein the micro USB pins are arranged in a row.

10. The micro USB plug of claim 1, wherein the grounding pin, the power pin, and the micro USB pins are arranged in a row.

11. The micro USB plug of claim 10, wherein the grounding pin extends from the interior further than the power pin.

12. The micro USB plug of claim 1, further comprising a locking mechanism attached to the housing and configured to engage and lock to USB equipment.

13. A micro universal serial bus (USB) plug system comprising:
a housing including a plurality of sides defining an interior therebetween, and including a first opening and a second opening defined within at least one of the sides, wherein the first opening and the second opening are positioned in a stacked arrangement;
a first slot and a second slot extending from the first opening and the second opening, respectively, towards the interior and structured to receive a micro USB version 2 plug and a micro USB version 3 plug, respectively;
a plurality of first pins positioned within the first slot and arranged to be operably connected to the micro USB version 2 plug, wherein the first pins are positioned horizontally with respect to the stacked arrangement; and
a plurality of second pins positioned within the second slot and arranged to be operably connected to the micro USB version 3 plug, wherein the second pins are positioned horizontally with respect to the stacked arrangement.

14. The micro USB plug system of claim 13, wherein the first pins comprise a Vcc pin, a transmit pin, a receive pin, and a ground pin.

15. The micro USB plug system of claim 13, further comprising micro USB version 2 circuitry contained within the interior and being operably connected to the first pins.

16. The micro USB plug system of claim 13, further comprising micro USB version 3 circuitry contained within the interior and being operably connected to the second pins.

17. The micro USB plug system of claim 13, wherein the first slot includes a constraint feature that prevents engagement with non-micro USB equipment.

18. The micro USB plug system of claim 13, wherein the first pins are arranged in a micro-B USB configuration.

19. The micro USB plug system of claim 13, wherein the first pins comprise a grounding pin, a power pin, and micro USB pins arranged in a row.

20. The micro USB plug system of claim 13, further comprising a locking mechanism attached to the housing and configured to engage and lock to USB equipment.
